(19) United States
(12) Patent Application Publication
(10) Pub. No.: US 2026/0145663 A1
(43) Pub. Date: May 28, 2026

(54) VEHICLE

(71) Applicant: SUBARU CORPORATION, Tokyo (JP)

(72) Inventor: Genta YANAGISAWA, Tokyo (JP)

(21) Appl. No.: 19/375,328

(22) Filed: Oct. 31, 2025

(30) Foreign Application Priority Data
Nov. 25, 2024 (JP) 2024-205056

(51) Int. Cl. B60W 20/50; B60K 6/24; B60K 6/26; B60K 6/365; B60W 10/06; B60W 10/08; B60W 20/10; H02P 5/747

(52) U.S. Cl. CPC B60W 20/50; B60K 6/24; B60K 6/26; B60K 6/365; B60W 10/06; B60W 10/08; B60W 20/10; H02P 5/747; B60W 2510/0638; B60W 2510/081; B60W 2540/10; B60W 2710/0644; B60W 2710/083; B60Y 2200/92; B60Y 2400/60; B60Y 2400/61

(57) ABSTRACT

A vehicle includes a planetary gear mechanism, an engine, first and second motor generators power converter, and a control device including a processor and a memory. The processor executes: determining, upon detecting of occurrence of abnormality in the motor generators, an estimated value of a control brake torque to act on the engine when an ON-state control operation is executed; determining a first target torque, which is greater than a current target torque of the engine by an amount equal to the estimated control brake torque; determining a delay time estimated to take until a current actual torque of the engine reaches the first target torque when the first target torque is set to the target torque; setting the first target torque to the target torque; and starting executing the control operation after a lapse of the delay time since the first target torque is set to the target torque.

### CROSS-REFERENCE TO RELATED APPLICATIONS

The present application claims priority from Japanese Patent Application No. 2024-205056 filed on Nov. 25, 2024, the entire contents of which are hereby incorporated by reference.

### BACKGROUND

The disclosure relates to a vehicle.

For example, Japanese Unexamined Patent Application Publication No. 2013-207833 discloses a hybrid vehicle including an engine, motor generators MG1 and MG2, and a power split device. In this hybrid vehicle, in response to detecting of the occurrence of abnormality in the motor generators MG1 and MG2, three-phase ON-state control is performed on the motor generator MG1 to generate drag torque in the motor generator MG1, thereby enabling the hybrid vehicle to perform emergency assist driving.

### SUMMARY

An aspect of the disclosure provides a vehicle. The vehicle includes a planetary gear mechanism, an engine, first and second motor generators, a first power converter, and a control device. The planetary gear mechanism includes a sun gear, a ring gear, a planet pinion, and a carrier. The carrier supports the planet pinion rotatably. The engine is coupled to the carrier. The first motor generator is coupled to the sun gear. The second motor generator is coupled to the ring gear and an axle. The first power converter is configured to electrically coupled to the first motor generator. The first power converter includes a plurality of arms connected in parallel to each other. Each of the arms includes a first switching element and a second switching element that are connected in series to each other between a positive electrode line and a negative electrode line. A node between the first switching element and the second switching element is connected to a winding of the first motor generator. The control device includes at least one processor and at least one memory coupled to the at least one processor. A first ON-state control operation is an operation to cause one of a group of the first switching elements of the arms and a group of the second switching elements of the arms to be in an ON state and the other one of the group of the first switching elements and the group of the second switching elements to be in an OFF state. A first ON-state control brake torque is a brake torque to act on the engine. The brake torque to act on the engine is caused by a brake torque generated in the first motor generator when the first ON-state control operation is executed. The at least one processor is configured to execute processing including: determining, in response to detecting of occurrence of abnormality in the first motor generator and the second motor generator, an estimated value of the first ON-state control brake torque which is to act on the engine when it is assumed that the first ON-state control operation is executed at a current time point; determining a first target torque, the first target torque being a torque greater than a target torque of the engine at a current time point by an amount equal to the estimated value of the first ON-state control brake torque; determining a delay time, the delay time being a period of time which is estimated to take until an actual torque of the engine at a current time point reaches the first target torque when it is assumed that the first target torque is set to the target torque of the engine at a current time point; setting the first target torque to the target torque of the engine; and starting executing the first ON-state control operation after a lapse of the delay time from a time point at which the first target torque is set to the target torque of the engine.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic view illustrating an example of the configuration of a vehicle according to an embodiment;

FIG. 2 is a circuit diagram illustrating an example of the electrical configuration of a first power converter and a first motor generator;

FIG. 3 illustrates an example of a collinear diagram based on the gear ratio of a planetary gear mechanism;

FIG. 4 is a flowchart illustrating an example of the operation of a vehicle controller of the vehicle according to the embodiment;

FIG. 5 illustrates an example of a first ON-state control brake torque table;

FIG. 6 is a graph illustrating the relationship between the rotational speed (rpm) of the first motor generator and the first ON-state control brake torque in the first ON-state control brake torque table;

FIG. 7 illustrates an example of a delay time map;

FIGS. 8A, 8B, and 8C are graphs for representing an overview of a control operation of a vehicle according to an embodiment;

FIG. 9 is a flowchart illustrating an example of the operation of a vehicle controller of the vehicle according to the embodiment;

FIG. 10 illustrates an example of a duty ratio map;

FIG. 11 is a flowchart illustrating an example of the operation of a vehicle controller of a vehicle according to an embodiment;

FIG. 12 is a flowchart illustrating an example of the operation of a vehicle controller of a vehicle according to an embodiment;

FIG. 13 is a flowchart illustrating an example of the operation of a vehicle controller of a vehicle according to an embodiment;

FIG. 14 illustrates an example of a first upper limit value table;

FIG. 15 is a flowchart illustrating an example of the operation of a vehicle controller of a vehicle according to an embodiment; and

FIG. 16 illustrates an example of a selection map.

### DETAILED DESCRIPTION

When three-phase ON-state control is performed on a motor generator MG1 of a vehicle, brake torque acts on the engine caused by drag torque generated in the motor generator MG1. Depending on the rotational speed of the engine when the three-phase ON-state control is started, the rotational speed of the engine may be decreased, which may lead to a stoppage of the engine. The vehicle may thus fail to perform emergency assist driving properly.

It is thus desirable to provide a vehicle that is able to perform emergency assist driving properly.

Embodiments of the disclosure will be described below in detail with reference to the accompanying drawings. Dimensions, materials, and numerical values, for example, discussed in the embodiments are only examples for easy understanding of the disclosure and are not intended to restrict the disclosure unless otherwise stated. In the specification and drawings, elements having substantially the same function or configuration are designated by like reference numeral and an explanation thereof will not be repeated. Elements that are not directly related to the disclosure are not illustrated in the drawings.

### First Embodiment

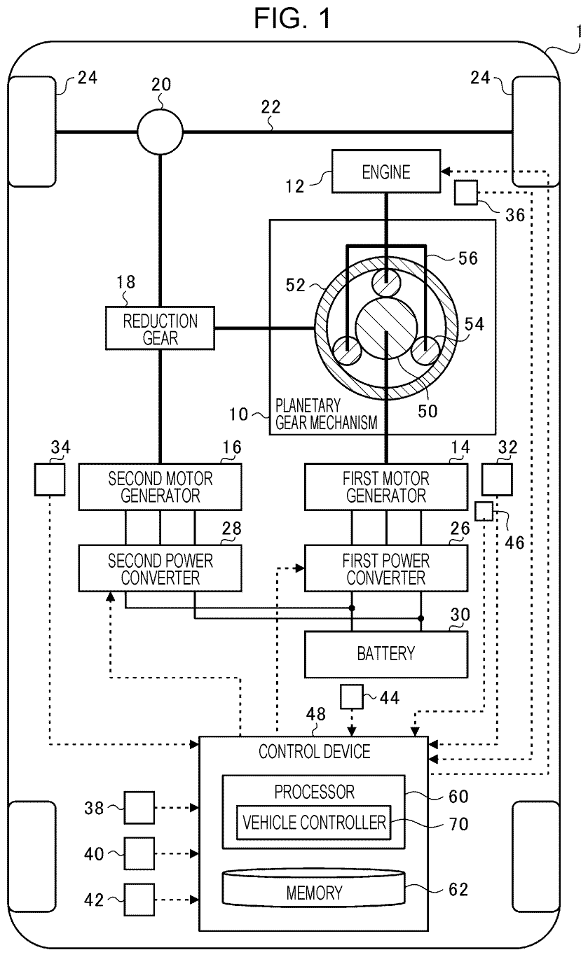

FIG. 1 is a schematic view illustrating an example of the configuration of a vehicle 1 according to a first embodiment. The vehicle 1 of the first embodiment includes a planetary gear mechanism 10, an engine 12, a first motor generator 14, a second motor generator 16, a reduction gear 18, a differential gear 20, an axle 22, wheels 24, a first power converter 26, a second power converter 28, a battery 30, a first resolver 32, a second resolver 34, an engine rotational speed (rpm) sensor 36, an accelerator sensor 38, a brake sensor 40, a vehicle velocity sensor 42, a voltage sensor 44, a temperature sensor 46, and a control device 48. For the sake of description, the motor generator may be abbreviated to the MG.

The planetary gear mechanism 10 includes a sun gear 50, a ring gear 52, a planet pinion 54, and a carrier 56. The sun gear 50 is formed in a disc-like shape, for example. The ring gear 52 is formed in a ring-like shape. The sun gear 50 is positioned inward of the ring gear 52 and is coaxially disposed with the ring gear 52. One or more planet pinions 54 are disposed between the sun gear 50 and the ring gear 52 and mesh with the sun gear 50 and the ring gear 52. In the embodiments of the disclosure, it is assumed that multiple planet pinions 54 are provided. The carrier 56 supports the planet pinions 54 rotatably. The planet pinions 54 are rotatable and can also revolve around the sun gear 50. The carrier 56 converts the revolution of the planet pinions 54 into the rotation of the carrier 56.

The engine 12 is a reciprocating engine, for example, and is a drive source for the vehicle 1. The engine 12 is coupled to the carrier 56 of the planetary gear mechanism 10.

The first motor generator 14 is coupled to the sun gear 50 of the planetary gear mechanism 10. The first motor generator 14 mainly serves as a generator that generates electricity in accordance with the driving of the engine 12, but may also serve as a motor.

The second motor generator 16 is coupled to the reduction gear 18. The ring gear 52 of the planetary gear mechanism 10 is coupled to the reduction gear 18. The reduction gear 18 is coupled to the axle 22 via the differential gear 20. That is, the second motor generator 16 is coupled to the ring gear 52 and the axle 22. The axle 22 is coupled to the wheels 24. The reduction gear 18 reduces the rotational speed (hereinafter simply called the RPM (revolutions per minute)) of the ring gear 52 and that of the second motor generator 16 and outputs the reduced speeds to the axle 22. The second motor generator 16 mainly serves as a motor for driving the vehicle 1, but may also serve as a generator.

The first power converter 26 is an inverter, for example, and is electrically coupled to the first motor generator 14 and the battery 30. The first power converter 26 performs power conversion between the first motor generator 14 and the battery 30. Details of the first power converter 26 will be discussed later.

The second power converter 28 is an inverter, for example, and is electrically coupled to the second motor generator 16 and the battery 30. The second power converter 28 performs power conversion between the second motor generator 16 and the battery 30. The configuration of the second power converter 28 is substantially the same as that of the first power converter 26.

The battery 30 is a rechargeable battery, such as a lithium-ion battery or a nickel-metal hydride battery. The battery 30 can supply electricity to the first motor generator 14 via the first power converter 26 and to the second motor generator 16 via the second power converter 28. The first motor generator 14 can charge the battery 30 via the first power converter 26, while the second motor generator 16 can charge the battery 30 via the second power converter 28.

The first resolver 32 is provided on the shaft of the first motor generator 14, for example, and detects the angle of rotation of the first motor generator 14. The second resolver 34 is provided on the shaft of the second motor generator 16, for example, and detects the angle of rotation of the second motor generator 16. The engine rotational speed sensor 36 is provided on the output shaft of the engine 12, for example, and detects the RPM of the engine 12.

The accelerator sensor 38 detects the amount by which a human driver steps on an accelerator pedal (not illustrated). Hereinafter, this amount will be called the accelerator operation amount. The accelerator sensor 38 may determine the accelerator operation amount by detecting the step-on angle of the accelerator pedal, for example. The brake sensor 40 detects the amount by which the human driver steps on a brake pedal (not illustrated). Hereinafter, this amount will be called the brake operation amount. The brake sensor 40 may determine the brake operation amount by detecting the step-on angle of the brake pedal, for example. The vehicle velocity sensor 42 detects the velocity of the vehicle 1, that is, the vehicle velocity. The vehicle velocity sensor 42 may detect the vehicle velocity by detecting the RPM of the wheels 24, for example.

The voltage sensor 44 detects the terminal voltage of the battery 30. The temperature sensor 46 detects the temperature of the first motor generator 14.

The control device 48 includes one or more processors 60 and one or more memories 62 connected to each other. In the embodiments of the disclosure, it is assumed that the control device 48 includes one processor 60 and one memory 62 connected to each other. The memory 62 includes a read only memory (ROM) storing a program, for example, and a random access memory (RAM) serving as a work area. The memory 62 may include a storage storing a program, for example. The processor 60 serves as a vehicle controller 70 in cooperation with the program stored in the memory 62.

The vehicle controller 70 controls the individual elements of the vehicle 1. For example, the vehicle controller 70 can control the engine 12. The vehicle controller 70 can control the first power converter 26 so as to practically control the first motor generator 14. The vehicle controller 70 can control the second power converter 28 so as to practically control the second motor generator 16.

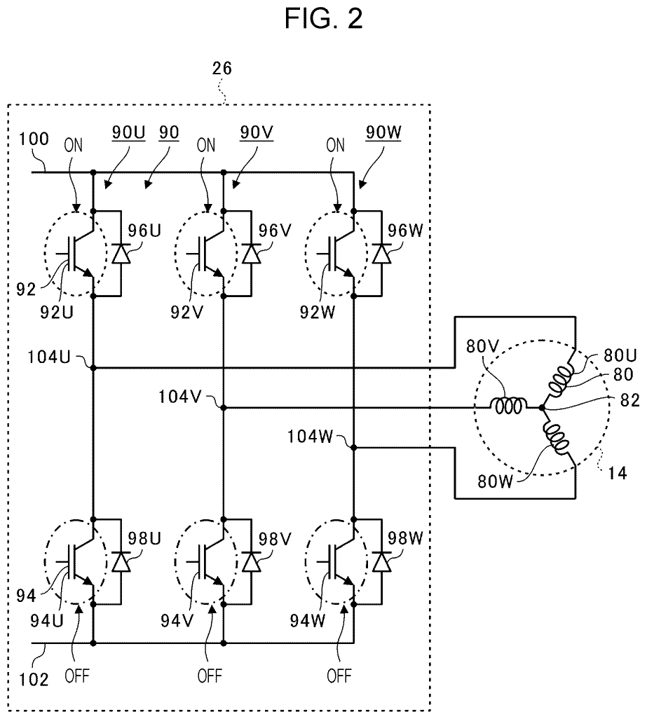

FIG. 2 is a circuit diagram illustrating an example of the electrical configuration of the first power converter 26 and the first motor generator 14. The electrical configuration of the second power converter 28 and the second motor generator 16 is substantially the same as that of the first power converter 26 and the first motor generator 14 and an explanation thereof will thus be omitted.

As illustrated in FIG. 2, the first motor generator 14 includes a U-phase winding 80U, a V-phase winding 80V, and a W-phase winding 80W. For the sake of explanation, the U-phase winding 80U, V-phase winding 80V, and W-phase winding 80W may collectively be simply called the windings 80.

The U-phase winding 80U, V-phase winding 80V, and W-phase winding are connected to each other by star connection, for example. In greater details, one end of the U-phase winding 80U, one end of the V-phase winding 80V, and one end of the W-phase winding 80W are connected to each other at a neutral point 82. A current flows through each winding 80 so that each winding 80 can generate a rotating magnetic field.

The first motor generator 14 is not limited to a three-phase motor including the three-phase windings 80. For example, the first motor generator 14 may be a single-phase motor or a multi-phase motor other than a three-phase motor. That is, the first motor generator 14 may include one or more windings 80.

The first power converter 26 includes a U-phase arm 90U, a V-phase arm 90V, and a W-phase arm 90W. For the sake of explanation, the U-phase arm 90U, V-phase arm 90V, and W-phase arm 90W may collectively be simply called the arms 90.

The U-phase arm 90U includes a U-phase first switching element 92U, a U-phase second switching element 94U, a U-phase first diode 96U, and a U-phase second diode 98U. The U-phase first switching element 92U and the U-phase second switching element 94U are connected in series to each other between a positive electrode line 100 and a negative electrode line 102. A node 104U between the U-phase first switching element 92U and the U-phase second switching element 94U is connected to an end of the U-phase winding 80U of the first motor generator 14 opposite the end connected to the neutral point 82. In other words, the U-phase first switching element 92U is disposed between the positive electrode line 100 and the node 104U, while the U-phase second switching element 94U is disposed between the node 104U and the negative electrode line 102.

The positive electrode line 100 is electrically connected to the positive electrode of the battery 30. The negative electrode line 102 is electrically connected to the negative electrode of the battery 30.

The U-phase first diode 96U is connected in parallel to the U-phase first switching element 92U in the opposite direction. The U-phase second diode 98U is connected in parallel to the U-phase second switching element 94U in the opposite direction.

The V-phase arm 90V includes a V-phase first switching element 92V, a V-phase second switching element 94V, a V-phase first diode 96V, and a V-phase second diode 98V. The V-phase first switching element 92V and the V-phase second switching element 94V are connected in series to each other between the positive electrode line 100 and the negative electrode line 102. A node 104V between the V-phase first switching element 92V and the V-phase second switching element 94V is connected to an end of the V-phase winding 80V of the first motor generator 14 opposite the end connected to the neutral point 82. In other words, the V-phase first switching element 92V is disposed between the positive electrode line 100 and the node 104V, while the V-phase second switching element 94V is disposed between the node 104V and the negative electrode line 102.

The V-phase first diode 96V is connected in parallel to the V-phase first switching element 92V in the opposite direction. The V-phase second diode 98V is connected in parallel to the V-phase second switching element 94V in the opposite direction.

The W-phase arm 90W includes a W-phase first switching element 92W, a W-phase second switching element 94W, a W-phase first diode 96W, and a W-phase second diode 98W. The W-phase first switching element 92W and the W-phase second switching element 94W are connected in series to each other between the positive electrode line 100 and the negative electrode line 102. A node 104W between the W-phase first switching element 92W and the W-phase second switching element 94W is connected to an end of the W-phase winding 80W of the first motor generator 14 opposite the end connected to the neutral point 82. In other words, the W-phase first switching element 92W is disposed between the positive electrode line 100 and the node 104W, while the W-phase second switching element 94W is disposed between the node 104W and the negative electrode line 102.

The W-phase first diode 96W is connected in parallel to the W-phase first switching element 92W in the opposite direction. The W-phase second diode 98W is connected in parallel to the W-phase second switching element 94W in the opposite direction.

In this manner, in the first power converter 26, the U-phase arm 90U, V-phase arm 90V, and W-phase arm 90W are connected in parallel to each other so as to form a three-phase full bridge circuit.

In FIG. 2, the first power converter 26 includes three arms 90 that form a three-phase full bridge circuit because the first motor generator 14 is a three-phase motor. However, the number of arms 90 forming the first power converter 26 is not limited to three. The first power converter 26 may include as many arms 90 as the phases of the first motor generator 14. That is, the first power converter 26 may include any multiple number of parallel-connected arms 90.

For the sake of explanation, the U-phase first switching element 92U, V-phase first switching element 92V, and W-phase first switching element 92W may collectively be simply called the first switching elements 92. Likewise, the U-phase second switching element 94U, V-phase second switching element 94V, and W-phase second switching element 94W may collectively be simply called the second switching elements 94. The first switching elements 92 and the second switching elements 94 may collectively be simply called the switching elements.

The vehicle controller 70 is able to control the ON/OFF state of each switching element of the first power converter 26. In one example of the control operation for the first power converter 26, the vehicle controller 70 can perform first OFF-state control and first ON-state control.

The first OFF-state control operation is to cause all the first switching elements 92 and all the second switching elements 94 of the arms 90 of the first power converter 26 to be in the OFF state.

Under the first OFF-state control, all the switching elements are in the OFF state. The three-phase full bridge circuit including the switching elements thus practically becomes a three-phase full bridge circuit only including the diodes. When the first motor generator 14 is rotated in this state, electricity regenerated in the first motor generator 14 is transferred to the battery 30 and is reused therein.

The first ON-state control operation is to cause one of a group of the first switching elements 92 and a group of the second switching elements 94 of the arms 90 to be in the ON state and the other one of the group of the first switching elements 92 and the group of the second switching elements 94 to be in the OFF state. For example, under the first ON-state control, as illustrated in FIG. 2, the U-phase first switching element 92U, V-phase first switching element 92V, and W-phase first switching element 92W are caused to be in the ON state, while the U-phase second switching element 94U, V-phase second switching element 94V, and W-phase second switching element 94W are caused to be in the OFF state. Alternatively, under the first ON-state control, the U-phase second switching element 94U, V-phase second switching element 94V, and W-phase second switching element 94W may be caused to be in the ON state, while the U-phase first switching element 92U, V-phase first switching element 92V, and W-phase first switching element 92W may be caused to be in the OFF state. When the first power converter 26 is a three-phase converter and the first motor generator 14 is a three-phase motor generator, the first ON-state control corresponds to what is known as three-phase ON-state control.

Under the first ON-state control, a closed circuit including the first switching elements 92 in the ON state and the windings 80 of the first motor generator 14 is formed. Under the first ON-state control, the positive electrode line 100 and the negative electrode line 102 are substantially disconnected from each other. In this state, when the first motor generator 14 is rotated, electricity regenerated in the first motor generator 14 is not transferred to the battery 30, but flows back to the closed circuit including the first switching elements 92 and the windings 80 and is converted into heat, which is consumed in the first motor generator 14, for example.

When the first motor generator 14 is rotated under the first ON-state control, a brake torque is generated in the output shaft of the first motor generator 14 so as to reduce its rotation since electricity regenerated in the first motor generator 14 flows back to the closed circuit as discussed above. The brake torque generated in the first motor generator 14 under the first ON-state control is sufficiently greater than that under the first OFF-state control.

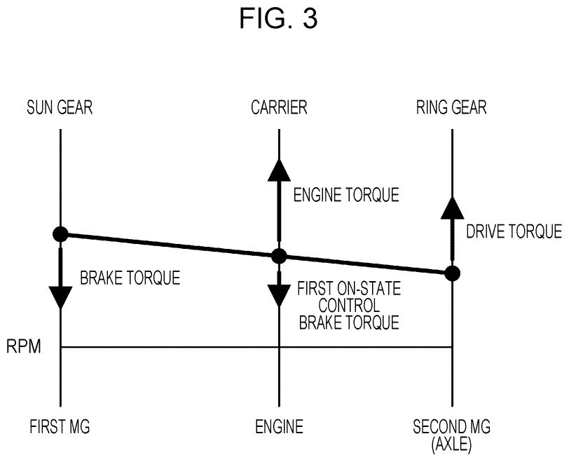

FIG. 3 illustrates an example of a collinear diagram based on the gear ratio of the planetary gear mechanism 10. The RPM of the sun gear 50 corresponds to that of the first motor generator 14. The RPM of the carrier 56 corresponds to that of the engine 12. The RPM of the ring gear 52 corresponds to that of the second motor generator 16 and that of the axle 22. In the collinear diagram in FIG. 3, the ratio of the interval between the vertical line of the sun gear 50 and that of the carrier 56 to the interval between the vertical line of the carrier 56 and that of the ring gear 52 corresponds to the gear ratio.

As illustrated in FIG. 3, the RPM of the first motor generator 14, the RPM of the engine 12, and the RPM of the second motor generator 16 (or the axle 22) are positioned substantially on the same line, that is, they substantially satisfy the collinearity.

When the RPM of the engine 12 is increased, torque of the engine 12 (engine torque) is raised. The torque of the engine 12 is split into the torque for rotating the first motor generator 14 and the torque for driving the axle 22 (drive torque) so as to rotate the first motor generator 14 and the axle 22.

As discussed above, when the first ON-state control is performed for the first power converter 26, the brake torque is generated in the first motor generator 14 in accordance with the rotation of the first motor generator 14. Due to this brake torque, a first ON-state control brake torque, which is a brake torque to reduce the rotation of the engine 12, is generated in the engine 12. The first ON-state control brake torque is a torque acting on the engine 12 which is converted from the brake torque generated in the first motor generator 14 based on the gear ratio of the planetary gear mechanism 10.

Given the gear ratio of the planetary gear mechanism 10, a decline in the RPM of the first motor generator 14 caused by the brake torque generated in the first motor generator 14 is likely to be greater than that of the RPM of the engine 12 caused by the first ON-state control brake torque acting on the engine 12. The RPM of the axle 22 can thus be raised because of the declining RPM of the first motor generator 14.

Additionally, if the torque of the engine 12 is raised to reduce the decline of the RPM of the engine 12 caused by the first ON-state control brake torque acting on the engine 12, the RPM of the axle 22 can be stably increased by the declining RPM of the first motor generator 14.

Abnormality may occur both in the first motor generator 14 and the second motor generator 16. For example, when the vehicle controller 70 has failed to obtain values from the first resolver 32 and the second resolver 34, it may determine that abnormality has occurred in the first motor generator 14 and the second motor generator 16.

In the case of the occurrence of such abnormality, the vehicle controller 70 performs the above-described first ON-state control for the first power converter 26, thereby enabling the vehicle 1 to perform emergency assist driving. As a result, safe driving can be secured and the vehicle 1 can be transported to a garage for repair, for example.

At the start point of the first ON-state control, however, if, for example, the RPM of the engine 12 is relatively low like the idling RPM, the engine 12 may stop because the first ON-state control brake torque acts on the engine 12. In this case, the vehicle 1 suddenly loses the driving force and may fail to perform emergency assist driving.

To address this issue, in the vehicle 1 of the first embodiment, in response to detecting of the occurrence of abnormality in the first motor generator 14 and the second motor generator 16, before starting the first ON-state control, the vehicle controller 70 first determines the estimated value of the first ON-state control brake torque which would be generated in the engine 12 if the first ON-state control were performed. The vehicle controller 70 then raises the torque of the engine 12 by the amount equal to the estimated value of the first ON-state control brake torque and then starts executing the first ON-state control.

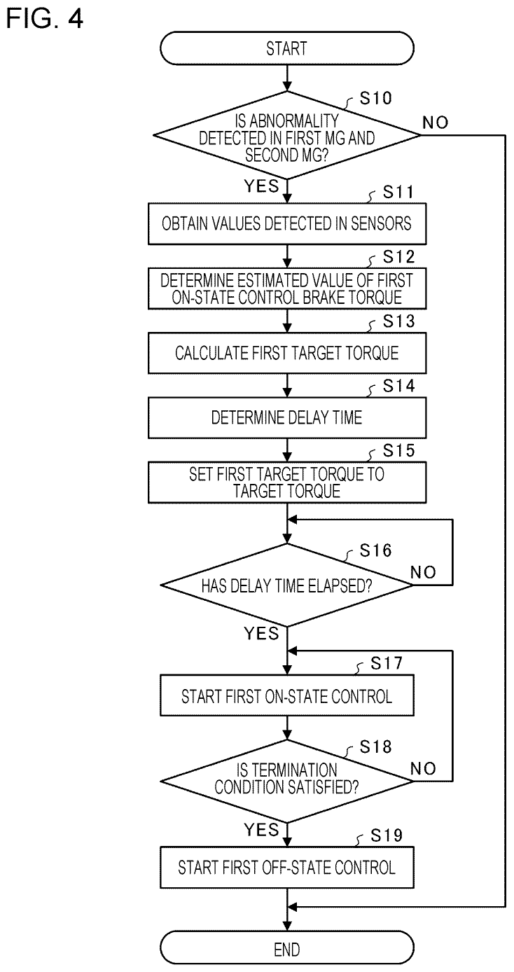

FIG. 4 is a flowchart illustrating an example of the operation of the vehicle controller 70 of the vehicle 1 according to the first embodiment. If the occurrence of abnormality is detected in both of the first motor generator 14 and the second motor generator 16 (YES in step S10), the vehicle controller 70 executes step S11 onwards. For example, if the vehicle controller 70 has failed to obtain values from both of the first resolver 32 and the second resolver 34, it may determine that the occurrence of abnormality in the first motor generator 14 and the second motor generator 16 is detected.

If the occurrence of abnormality is detected neither in the first motor generator 14 nor the second motor generator 16 or if it is detected in only one of the first motor generator 14 and the second motor generator 16 (NO in step S10), the vehicle controller 70 terminates the processing in FIG. 4 and executes regular processing.

In step S11, the vehicle controller 70 obtains values detected in individual sensors. For example, the vehicle controller 70 may obtain the actual RPM of the engine 12 detected by the engine rotational speed sensor 36. The vehicle controller 70 may obtain the vehicle velocity detected by the vehicle velocity sensor 42. The vehicle controller 70 may obtain the accelerator operation amount detected by the accelerator sensor 38. The vehicle controller 70 may obtain the brake operation amount detected by the brake sensor 40.

In step S12, the vehicle controller 70 determines the estimated value of the first ON-state control brake torque to act on the engine 12, based on the current vehicle velocity, the actual RPM of the engine 12, the gear ratio of the planetary gear mechanism 10, and the gear ratio of the reduction gear 18.

For example, the vehicle controller 70 calculates the current RPM of the second motor generator 16 (in other words, the RPM of the ring gear 52), based on the current vehicle velocity and the gear ratio of the reduction gear 18. The vehicle controller 70 then calculates the current RPM of the first motor generator 14 (in other words, the RPM of the sun gear 50), based on the current RPM of the second motor generator 16, the current actual RPM of the engine 12, and the gear ratio of the planetary gear mechanism 10. The vehicle controller 70 then determines the estimated value of the first ON-state control brake torque to act on the engine 12, based on the RPM of the first motor generator 14 and a first ON-state control brake torque table prestored in the memory 62.

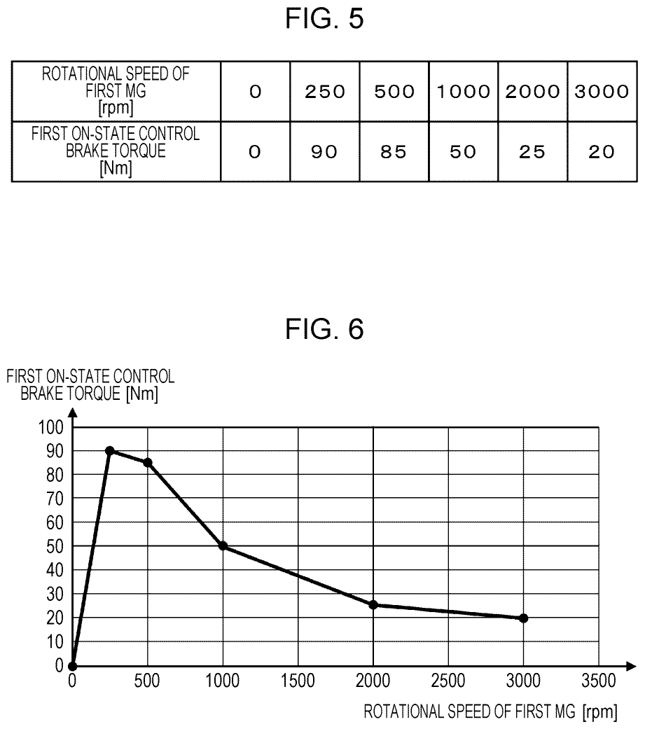

FIG. 5 illustrates an example of the first ON-state control brake torque table. As illustrated in FIG. 5, the first ON-state control brake torque table is a table in which the RPM of the first motor generator 14 and the first ON-state control brake torque are correlated to each other. The first ON-state control brake torque is a brake torque to act on the engine 12 caused by the brake torque generated in the first motor generator 14 when the vehicle controller 70 performs the first ON-state control for the first power converter 26. The first ON-state control brake torque is expressed by the absolute value, as illustrated in FIG. 5.

FIG. 6 is a graph illustrating the relationship between the RPM of the first motor generator 14 and the first ON-state control brake torque in the first ON-state control brake torque table. As illustrated in FIG. 6, the first ON-state control brake torque soars when the RPM of the first motor generator 14 is relatively low, such as about 250 rpm.

The numerical values of the first ON-state control brake torque and the RPM of the first motor generator 14 are not limited to those in FIGS. 5 and 6, and they may be set to various values depending on the specifications of the first motor generator 14 and the gear ratio of the planet pinions 54.

Referring back to FIG. 4, after step S12, in step S13, the vehicle controller 70 calculates a first target torque, which is a torque greater than the current target torque of the engine 12 by the amount equal to the estimated value of the first ON-state control brake torque. For example, when the first ON-state control brake torque is expressed by the absolute value, the vehicle controller 70 calculates the first target torque by adding the estimated value of the first ON-state control brake torque determined in step S12 to the current target torque of the engine 12.

In step S14, the vehicle controller 70 determines a delay time. The delay time is a period of time estimated to take until the current actual torque of the engine 12 reaches the first target torque if it is assumed that the first target torque is set to the current target torque of the engine 12.

For example, the vehicle controller 70 determines the charging efficiency representing the air volume contributing to the combustion of the engine 12, based on the current accelerator operation amount. The vehicle controller 70 then determines the delay time, based on the current charging efficiency of the engine 12, the current actual RPM of the engine 12, and a delay time map prestored in the memory 62.

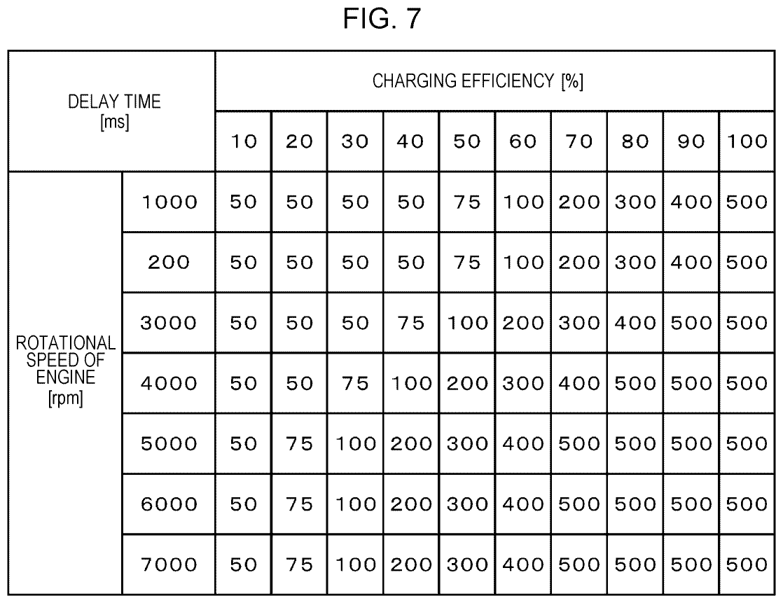

FIG. 7 illustrates an example of the delay time map. As illustrated in FIG. 7, the delay time map is a map in which the charging efficiency, the RPM of the engine 12, and the delay time are correlated to each other. In the delay time map, the delay time is set to become longer as the charging efficiency of the engine 12 becomes higher and as the RPM of the engine 12 becomes larger.

The specific numerical values in the delay time map are not limited to those in FIG. 7, and they may be set to various values depending on the specifications of the engine 12, for example.

Referring back to FIG. 4, after step S14, in step S15, the vehicle controller 70 sets the first target torque calculated in step S13 to the target torque of the engine 12. This means that the actual torque of the engine 12 rises to the first target torque calculated in step S13.

In step S16, the vehicle controller 70 determines whether the delay time set in step S14 has elapsed from the time point at which the first target torque is set to the target torque of the engine 12, that is, when step S15 is executed. If the result of step S16 is NO, the vehicle controller 70 waits until the delay time has elapsed.

If the delay time is found to have elapsed (YES in step S16), the vehicle controller 70 starts the first ON-state control for the first power converter 26 in step S17.

The vehicle controller 70 determines in step S18 whether a condition for terminating the first ON-state control is satisfied. If the result of step S18 is NO, the vehicle controller 70 returns to step S17 and continues executing the first ON-state control until this termination condition is satisfied. The vehicle controller 70 may determine that the termination condition is satisfied when, for example, the ignition of the vehicle 1 is turned OFF or an input operation for completing emergency assist driving is performed on a certain button or another part of the vehicle 1.

If the termination condition is found to be satisfied (YES in step S18), the vehicle controller 70 switches to the first OFF-state control for the first power converter 26 in step S19 and then completes the processing in FIG. 4.

As described above, in the first embodiment, if the occurrence of abnormality in the first motor generator 14 and the second motor generator 16 is detected, the actual torque of the engine 12 is first raised substantially by the amount equal to the estimated value of the first ON-state control brake torque, and then, the first ON-state control is started.

In the vehicle 1 of the first embodiment, therefore, a stoppage of the engine 12 caused by the start of the first ON-state control can be avoided. As a result, emergency assist driving can be performed properly to handle the occurrence of abnormality in the first motor generator 14 and the second motor generator 16.

### Second Embodiment

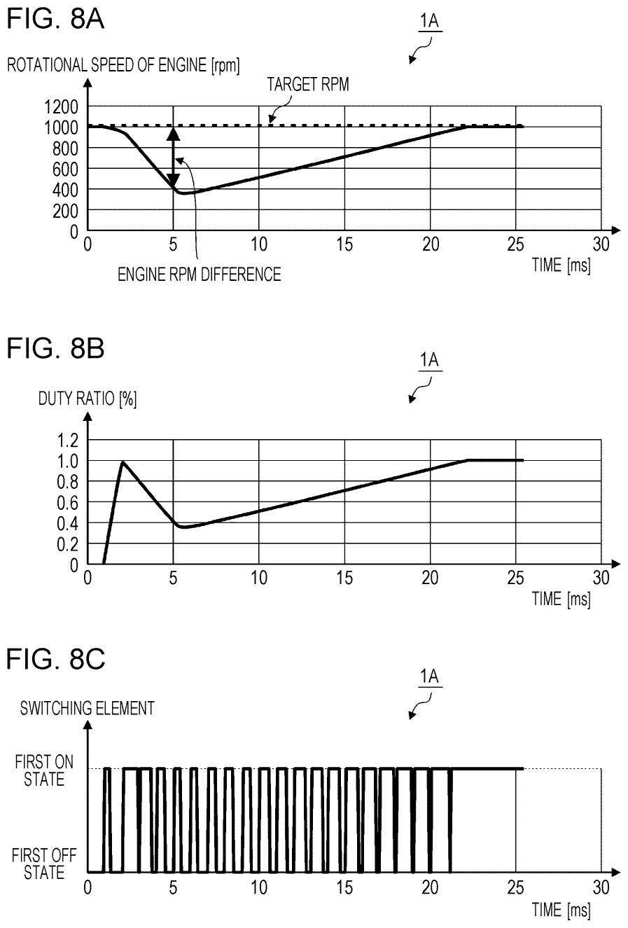

FIGS. 8A, 8B, and 8C are graphs for representing an overview of the control operation of a vehicle 1A according to a second embodiment. The configuration of the vehicle 1A of the second embodiment is substantially the same as that of the vehicle 1 of the first embodiment. The vehicle 1A of the second embodiment is different from the vehicle 1 of the first embodiment in the control operation of the vehicle controller 70. The second embodiment will be explained below by referring to the points different from the first embodiment while omitting an explanation of the same points as those of the first embodiment for the sake of convenience.

In the second embodiment, in response to detecting of the occurrence of abnormality in the first motor generator 14 and the second motor generator 16, the vehicle controller 70 starts the first ON-state control for the first power converter 26, as in the first embodiment. In this case, in the second embodiment, the torque of the engine 12 may be first raised, and then, the first ON-state control may be started, as in the first embodiment. Alternatively, unlike the first embodiment, the first ON-state control may be immediately started without raising the torque of the engine 12.

As discussed above, when the first ON-state control is performed, the first ON-state control brake torque acts on the engine 12, which lowers the RPM of the engine 12 and may lead to a stoppage of the engine 12.

To deal with this situation, in the vehicle 1A of the second embodiment, after starting the first ON-state control, the vehicle controller 70 performs intermittent control to alternately repeat the first ON-state control and the first OFF-state control in a pulsating manner. That is, the vehicle controller 70 of the vehicle 1A alternately repeats the execution of the first ON-state control and the temporal cancellation of the first ON-state control in a short cycle.

In FIG. 8C, “first ON state” represents that the first switching elements 92 are ON and the first ON-state control is being executed. In FIG. 8C, “first OFF state” represents that the first switching elements 92 are OFF and the execution of the first ON-state control is temporarily stopped and the first OFF-state control is being executed.

As illustrated in FIG. 8C, alternately repeating the first ON-state control and the first OFF-state control practically makes the execution time of the first ON-state control shorter than when the first ON-state control is continuously performed.

With this control operation, in the vehicle 1A of the second embodiment, even when the first ON-state control is started to handle the occurrence of abnormality in the first motor generator 14 and the second motor generator 16, the RPM of the engine 12 is less likely to decline, which thus makes it less likely to stop the engine 12.

The vehicle controller 70 of the vehicle 1A may also control the duty ratio, which is the ratio of the execution time of the first ON-state control to the length of one cycle of the intermittent control operation, based on the engine RPM difference. The engine RPM difference is a difference between the target RPM of the engine 12 and the actual RPM of the engine 12. In greater details, the vehicle controller 70 may change the duty ratio of the intermittent control operation based on the engine RPM difference so that the duty ratio becomes smaller as the engine RPM difference becomes greater.

For example, in FIG. 8C, the first ON-state control is started at about one millisecond (1 ms), and then, the intermittent control is executed. After the first ON-state control is started, the RPM of the engine is decreased in the period from about 2 ms to 5 ms in FIG. 8A. Declining of the RPM of the engine 12 increases the engine RPM difference. Then, as is seen from about 2 ms to 5 ms in FIG. 8B, the vehicle controller 70 lowers the duty ratio in accordance with the increased engine RPM difference. This practically makes the execution time of the first ON-state control shorter, thereby making it more likely to reduce a decline in the RPM of the engine 12.

As is seen from about 5 ms to 22 ms in FIG. 8A, for example, when the RPM of the engine 12 is gradually recovering from a decline, the engine RPM difference gradually becomes smaller. Then, as is seen from about 5 ms to 22 ms in FIG. 8B, the vehicle controller 70 gradually raises the duty ratio in accordance with the decreased engine RPM difference. This practically makes the execution time of the first ON-state control longer, thereby making it less likely to reduce a decline in the RPM of the engine 12.

In this manner, in the vehicle 1A of the second embodiment, changing the duty ratio based on the engine RPM difference can adjust the amount by which a decline in the RPM of the engine 12 is reduced. As a result, the vehicle 1A can make variations in the RPM of the engine 12 smaller, in other words, it can make the behavior of the vehicle 1A smoother.

The vehicle controller 70 may control the duty ratio so that the duty ratio can be prevented from soaring after the first ON-state control is started as is seen from about 1 ms to 2 ms in FIG. 8B.

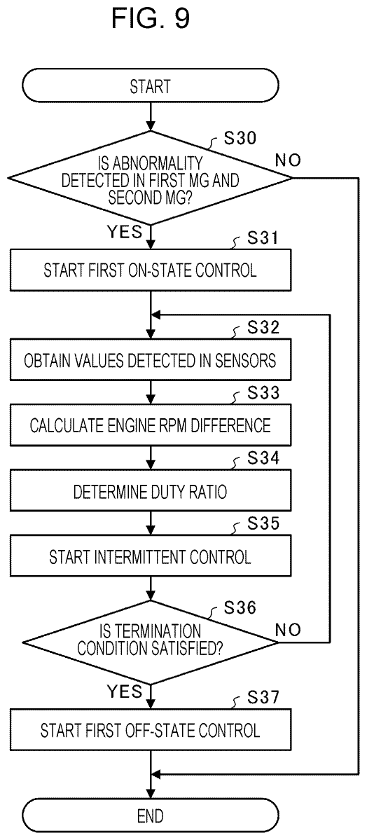

FIG. 9 is a flowchart illustrating an example of the operation of the vehicle controller 70 of the vehicle 1A according to the second embodiment. If the occurrence of abnormality is detected in both of the first motor generator 14 and the second motor generator 16 (YES in step S30), the vehicle controller 70 executes step S31 onwards. For example, if the vehicle controller 70 has failed to obtain values from both of the first resolver 32 and the second resolver 34, it may determine that the occurrence of abnormality in the first motor generator 14 and the second motor generator 16 is detected.

If the occurrence of abnormality is detected neither in the first motor generator 14 nor the second motor generator 16 or if it is detected in only one of the first motor generator 14 and the second motor generator 16 (NO in step S30), the vehicle controller 70 terminates the processing in FIG. 9 and executes regular processing.

In step S31, the vehicle controller 70 starts the first ON-state control for the first power converter 26.

In step S32, the vehicle controller 70 obtains values detected in individual sensors. For example, the vehicle controller 70 may obtain the actual RPM of the engine 12 detected by the engine rotational speed sensor 36. The vehicle controller 70 may obtain the vehicle velocity detected by the vehicle velocity sensor 42. The vehicle controller 70 may obtain the accelerator operation amount detected by the accelerator sensor 38. The vehicle controller 70 may obtain the brake operation amount detected by the brake sensor 40.

In step S33, the vehicle controller 70 calculates the current engine RPM difference by subtracting the current actual RPM of the engine 12 from the current target RPM of the engine 12.

In step S34, the vehicle controller 70 determines the duty ratio to be used in the intermittent control operation, based on the current engine RPM difference. For example, the vehicle controller 70 calculates the current driving force intended by the human driver, based on the current accelerator operation amount and the current brake operation amount. The vehicle controller 70 then determines the duty ratio to be used in the intermittent control operation, based on the current engine RPM difference, the current driving force intended by the human driver, and a duty ratio map prestored in the memory 62.

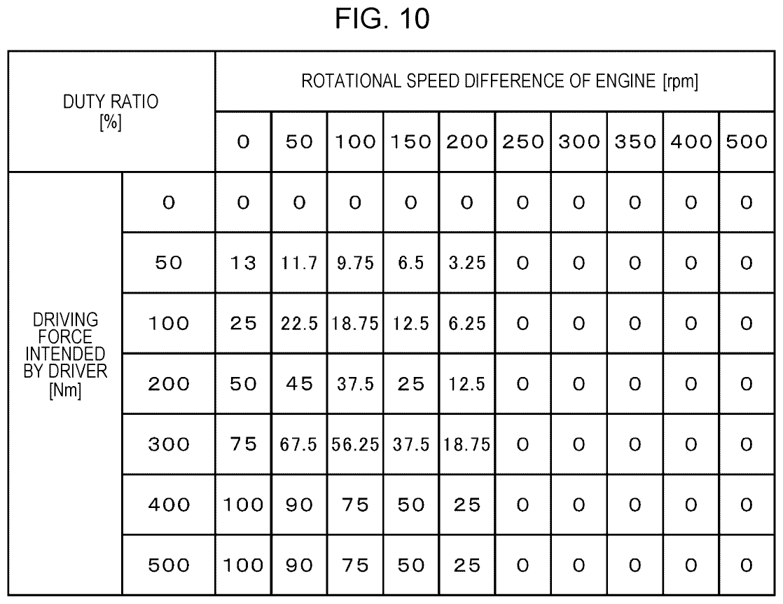

FIG. 10 illustrates an example of the duty ratio map. As illustrated in FIG. 10, the duty ratio map is a map in which the engine RPM difference, the driving force intended by the driver, and the duty ratio used in the intermittent control are correlated to each other. In the duty ratio map, the duty ratio is set such that, as the engine RPM difference becomes greater, the duty ratio becomes lower, and as the driving force intended by the driver becomes greater, the duty ratio becomes higher.

Referring back to FIG. 9, after step S34, in step S35, the vehicle controller 70 executes the intermittent control in accordance with the duty ratio determined in step S34. If the determined duty ratio is 100%, it means that the intermittent control is practically the same as the continuous execution of the first ON-state control.

The vehicle controller 70 determines in step S36 whether a condition for terminating the first ON-state control is satisfied. If the result of step S36 is NO, the vehicle controller 70 returns to step S32 and continues the intermittent control operation until this termination condition is satisfied. The vehicle controller 70 may determine that the termination condition is satisfied when, for example, the ignition of the vehicle 1A is turned OFF or an input operation for completing emergency assist driving is performed on a certain button or another part of the vehicle 1A.

If the termination condition is found to be satisfied (YES in step S36), the vehicle controller 70 switches to the first OFF-state control for the first power converter 26 in step S37 and then completes the processing in FIG. 9.

### Third Embodiment

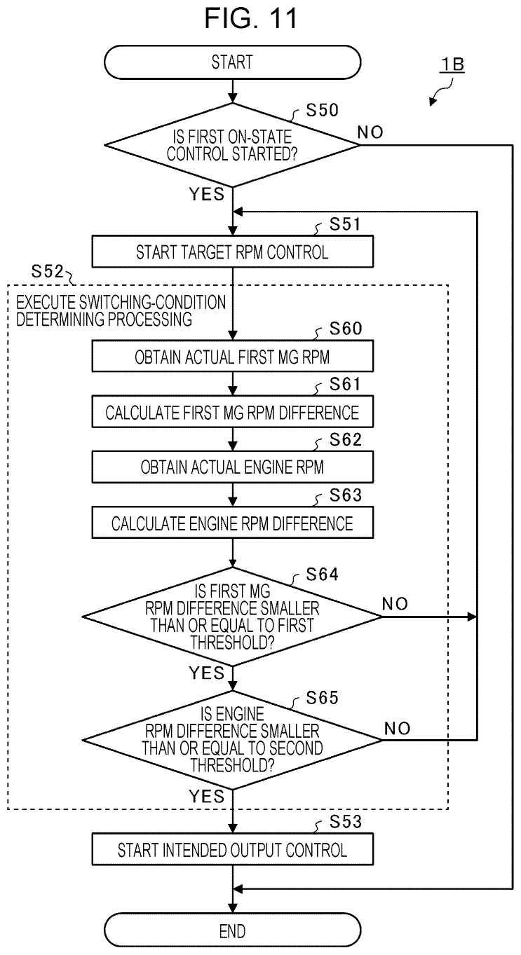

FIG. 11 is a flowchart illustrating an example of the operation of the vehicle controller 70 of a vehicle 1B according to a third embodiment. The configuration of the vehicle 1B of the third embodiment is substantially the same as that of the vehicle 1 of the first embodiment. The vehicle 1B of the third embodiment is different from the vehicle 1 of the first embodiment in the control operation of the vehicle controller 70. The third embodiment will be explained below by referring to the points different from the first embodiment while omitting an explanation of the same points as those of the first embodiment for the sake of convenience.

In the third embodiment, in response to detecting of the occurrence of abnormality in the first motor generator 14 and the second motor generator 16, the vehicle controller 70 performs the first ON-state control for the first power converter 26, as in the first embodiment. In this case, in the third embodiment, the torque of the engine 12 may be first raised, and then, the first ON-state control may be started, as in the first embodiment. Alternatively, unlike the first embodiment, the first ON-state control may be immediately started without raising the torque of the engine 12.

During the execution of the first ON-state control, when the RPM of the first motor generator 14 becomes relatively low, which is almost 0, the brake torque generated in the first motor generator 14 becomes maximized. For the sake of explanation, the RPM of the first motor generator 14 when the brake torque generated in the first motor generator 14 is maximized may be called the peak RPM.

As discussed above, when the first ON-state control is started and is continued, the RPM of the first motor generator 14 is gradually lowered due to the brake torque generated in the first motor generator 14 and may reach the peak RPM. In this case, the driving force of the axle 22, which is changed in accordance with a variation in the RPM of the first motor generator 14, is maximized.

When the RPM of the first motor generator 14 reaches the peak RPM, the actual RPM of the engine 12 may reach the target RPM, which is the RPM of the engine 12 when the RPM of the first motor generator 14 reaches the peak RPM. Hence, when the RPM of the first motor generator 14 reaches the peak RPM, the diving force of the axle 22 may not be raised any longer. As a result, it may not be possible to sufficiently accelerate the vehicle 1B that is performing emergency assist driving.

To address this issue, in the vehicle 1B of the third embodiment, in response to starting of the first ON-state control, the vehicle controller 70 executes target RPM control to control the engine 12 so that the actual RPM of the engine 12 becomes the target RPM of the engine 12. Then, if a predetermined switching condition is satisfied during the execution of the target RPM control, the vehicle controller 70 switches to intended output control to control the engine 12 so that output of the engine 12 becomes intended output based on the accelerator operation amount.

The above-described switching condition is a condition that the RPM difference of the first motor generator 14, which is a difference between the actual RPM of the first motor generator 14 and the target RPM of the first motor generator 14, is smaller than or equal to a predetermined first threshold and that the engine RPM difference between the actual RPM of the engine 12 and the target RPM of the engine 12 is smaller than or equal to a predetermined second threshold.

The first threshold may be set to a value based on which the vehicle controller 70 can determine that the RPM difference of the first motor generator 14 is substantially 0 within the tolerance. The target RPM of the first motor generator 14 is set to the peak RPM, for example. In this case, determining whether the condition that the RPM difference of the first motor generator 14 is smaller than or equal to the first threshold is satisfied is to determine whether the actual RPM of the first motor generator 14 substantially reaches the target RPM of the first motor generator 14, namely, the peak RPM.

The second threshold may be set to a value based on which the vehicle controller 70 can determine that the engine RPM difference is substantially 0 within the tolerance. Determining whether the condition that the engine RPM difference is smaller than or equal to the second threshold is satisfied is to determine whether the actual RPM of the engine 12 is maintained substantially at the target RPM of the engine 12. In other words, determining whether the condition that the engine RPM difference is smaller than or equal to the second threshold is satisfied is to determine whether the engine 12 can be prevented from a stoppage due to the first ON-state control brake torque.

In this manner, in the vehicle 1B of the third embodiment, the engine 12 is under the target RPM control during a period from when the first ON-state control is started until the switching condition is satisfied.

With this control operation, in the vehicle 1B of the third embodiment, the driving force of the axle 22 can be suitably raised in accordance with the brake torque generated in the first motor generator 14 under the first ON-state control.

In the vehicle 1B of the third embodiment, if it is determined that the RPM of the first motor generator 14 substantially reaches the peak RPM and that the engine 12 can be prevented from a stoppage which would be caused by the first ON-state control brake torque, the target RPM control is switched to the intended output control.

With this switching operation, in the vehicle 1B of the third embodiment, even after the RPM of the first motor generator 14 reaches the peak RPM, the driving force of the axle 22 can be suitably raised in accordance with the increased torque of the engine 12 under the intended output control.

As illustrated in FIG. 11, in the vehicle 1B of the third embodiment, the vehicle controller 70 determines in step S50 whether the first ON-state control is started. If the first ON-state control is found to be started (YES in step S50), the vehicle controller 70 executes step S51 onwards. If it is determined that the first ON-state control is not started (NO in step S50), the vehicle controller 70 terminates the processing in FIG. 11 and executes regular processing.

In step S51, the vehicle controller 70 executes the target RPM control to control the engine 12.

In step S52, the vehicle controller 70 determines whether the predetermined switching condition, which is used for determining whether to switch the control operation for the engine 12, is satisfied. If it is found that the switching condition is not satisfied (NO in step S64 or S65 in step S52), the vehicle controller 70 maintains the target RPM control in step S51. If the switching condition is found to be satisfied (YES in steps S64 and S65 in step S52), the vehicle controller 70 switches from the target RPM control to the intended output control to control the engine 12.

In the switching-condition determining processing executed in step S52, the vehicle controller 70 first obtains the current actual RPM of the first motor generator 14 in step S60. For example, the vehicle controller 70 calculates the current RPM of the first motor generator 14 as follows. The vehicle controller 70 first calculates the current RPM of the second motor generator 16 (in other words, the RPM of the ring gear 52), based on the current vehicle velocity and the gear ratio of the reduction gear 18. The vehicle controller 70 then calculates the current RPM of the first motor generator 14 (in other words, the RPM of the sun gear 50), based on the current RPM of the second motor generator 16, the current actual RPM of the engine 12, and the gear ratio of the planetary gear mechanism 10. The vehicle controller 70 sets the calculated current RPM of the first motor generator 14 to the current actual RPM of the first motor generator 14.

Then, in step S61, the vehicle controller 70 calculates the RPM difference of the first motor generator 14 by subtracting the current actual RPM of the first motor generator 14 from the current target RPM of the first motor generator 14.

Then, in step S62, the vehicle controller 70 obtains the current actual RPM of the engine 12 from the value detected by the engine rotational speed sensor 36.

In step S63, the vehicle controller 70 calculates the current engine RPM difference by subtracting the current actual RPM of the engine 12 from the current target RPM of the engine 12.

The vehicle controller 70 then determines in step S64 whether the current RPM difference of the first motor generator 14 is smaller than or equal to the predetermined first threshold. If the current RPM difference of the first motor generator 14 is found to be smaller than or equal to the first threshold (YES in step S64), the vehicle controller 70 determines in step S65 whether the current engine RPM difference is smaller than or equal to the predetermined second threshold.

If the current RPM difference of the first motor generator 14 is found to be smaller than or equal to the first threshold (YES in step S64) and if the current engine RPM difference is found to be smaller than or equal to the second threshold (YES in step S65), the vehicle controller 70 determines that the switching condition is satisfied and switches to the intended output control in step S53.

If the current RPM difference of the first motor generator 14 is found to be greater than the first threshold (NO in step S64) or if the current engine RPM difference is found to be greater than the second threshold (NO in step S65), the vehicle controller 70 determines that the switching condition is not satisfied and maintains the target RPM control in step S51.

### Fourth Embodiment

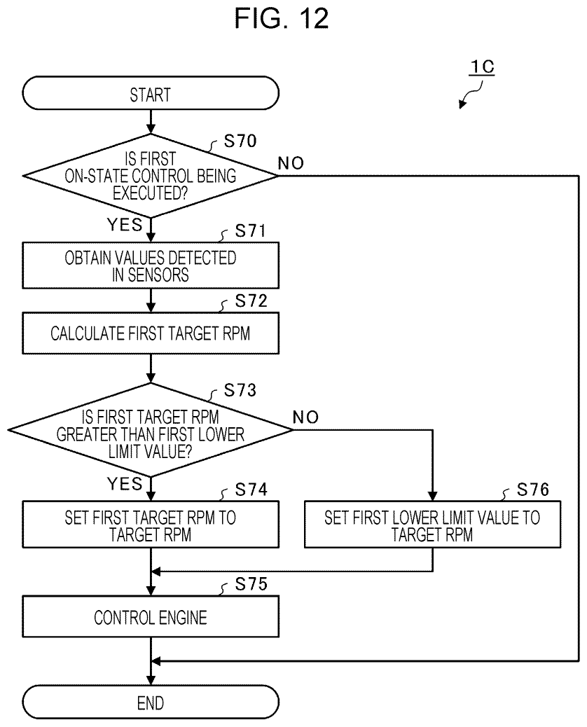

FIG. 12 is a flowchart illustrating an example of the operation of the vehicle controller 70 of a vehicle 1C according to a fourth embodiment. The configuration of the vehicle 1C of the fourth embodiment is substantially the same as that of the vehicle 1 of the first embodiment. The vehicle 1C of the fourth embodiment is different from the vehicle 1 of the first embodiment in the control operation of the vehicle controller 70. The fourth embodiment will be explained below by referring to the points different from the first embodiment while omitting an explanation of the same points as those of the first embodiment for the sake of convenience.

In the fourth embodiment, in response to detecting of the occurrence of abnormality in the first motor generator 14 and the second motor generator 16, the vehicle controller 70 performs the first ON-state control for the first power converter 26, as in the first embodiment. In this case, in the fourth embodiment, the torque of the engine 12 may be first raised, and then, the first ON-state control may be started, as in the first embodiment. Alternatively, unlike the first embodiment, the first ON-state control may be immediately started without raising the torque of the engine 12.

As discussed in the third embodiment, when the first ON-state control is started and is continued, the RPM of the first motor generator 14 is gradually lowered due to the brake torque generated in the first motor generator 14.

If the RPM of the first motor generator 14 approaches the peak RPM, the first ON-state control brake torque acts on the engine 12 and the RPM of the engine 12 may become lower than the RPM that can maintain the driving of the engine 12, which may lead to a stoppage of the engine 12.

To address this issue, in the vehicle 1C of the fourth embodiment, a first lower limit value, which is a lower limit value of the RPM of the engine 12 during the execution of the first ON-state control, is preset. The first lower limit value may be set to a value larger than the RPM that can mechanically stop the engine 12 and also closer to this RPM. For example, the first lower limit value may be set to a value (600 rpm, for example) lower than the lower limit value of the RPM of the engine 12 in the regular idling state (1000 rpm, for example).

In the vehicle 1C of the fourth embodiment, the vehicle controller 70 calculates a first target RPM of the engine 12, based on the RPM of the first motor generator 14 when the brake torque generated in the first motor generator 14 is maximized under the first ON-state control, that is, based on the above-described peak RPM. The peak RPM of the first motor generator 14 may be prestored in the memory 62, for example.

In the vehicle 1C of the fourth embodiment, during the execution of the first ON-state control, if the first target RPM is greater than the first lower limit value, the vehicle controller 70 sets the first target RPM to the target RPM of the engine 12 and controls the engine 12. During the execution of the first ON-state control, if the first target RPM is smaller than or equal to the first lower limit value, the vehicle controller 70 sets the first lower limit value to the target RPM of the engine 12 and controls the engine 12.

In this manner, in the vehicle 1C of the fourth embodiment, if the first target RPM is smaller than or equal to the first lower limit value, the target RPM of the engine 12 is restricted to the first lower limit value so as not to become lower than the first lower limit value.

With this control operation, the target RPM of the engine 12 does not become lower than the first lower limit value, thereby preventing the engine 12 from being mechanically stopped.

After detecting the occurrence of abnormality in the first motor generator 14 and the second motor generator 16, the vehicle controller 70 of the vehicle 1C of the fourth embodiment may execute processing illustrated in FIG. 12 at predetermined intervals. In step S70 in FIG. 12, the vehicle controller 70 determines whether the first ON-state control is being executed for the first power converter 26. If it is determined that the first ON-state control is not being executed (NO in step S70), the vehicle controller 70 terminates the processing in FIG. 12.

If it is determined that the first ON-state control is being executed (YES in step S70), the vehicle controller 70 obtains values detected in individual sensors in step S71. For example, the vehicle controller 70 may obtain the vehicle velocity detected by the vehicle velocity sensor 42.

In step S72, the vehicle controller 70 calculates the first target RPM of the engine 12, based on the current vehicle velocity and the peak RPM of the first motor generator 14. For example, the vehicle controller 70 calculates the RPM of the engine 12 as follows. The vehicle controller 70 first calculates the current RPM of the second motor generator 16 (in other words, the RPM of the ring gear 52), based on the current vehicle velocity and the gear ratio of the reduction gear 18. The vehicle controller 70 then calculates the RPM of the engine 12 (in other words, the RPM of the carrier 52), based on the current RPM of the second motor generator 16, the peak RPM of the first motor generator 14, and the gear ratio of the planetary gear mechanism 10. The vehicle controller 70 then sets the calculated RPM of the engine 12 to the first target RPM of the engine 12.

The vehicle controller 70 then determines in step S73 whether the current first target RPM of the engine 12 calculated in step S72 is greater than the preset first lower limit value.

If the current first target RPM of the engine 12 is found to be greater than the first lower limit value (YES in step S73), the vehicle controller 70 sets the current first target RPM of the engine 12 to the target RPM of the engine 12 in step S74. Then, in step S75, the vehicle controller 70 controls the engine 12 in accordance with the set target RPM, that is, the current first target RPM of the engine 12.

If the current first target RPM of the engine 12 is found to be smaller than or equal to the first lower limit value (NO in step S73), the vehicle controller 70 sets the first lower limit value to the target RPM of the engine 12 in step S76. Then, in step S75, the vehicle controller 70 controls the engine 12 in accordance with the set target RPM, that is, the first lower limit value.

### Fifth Embodiment

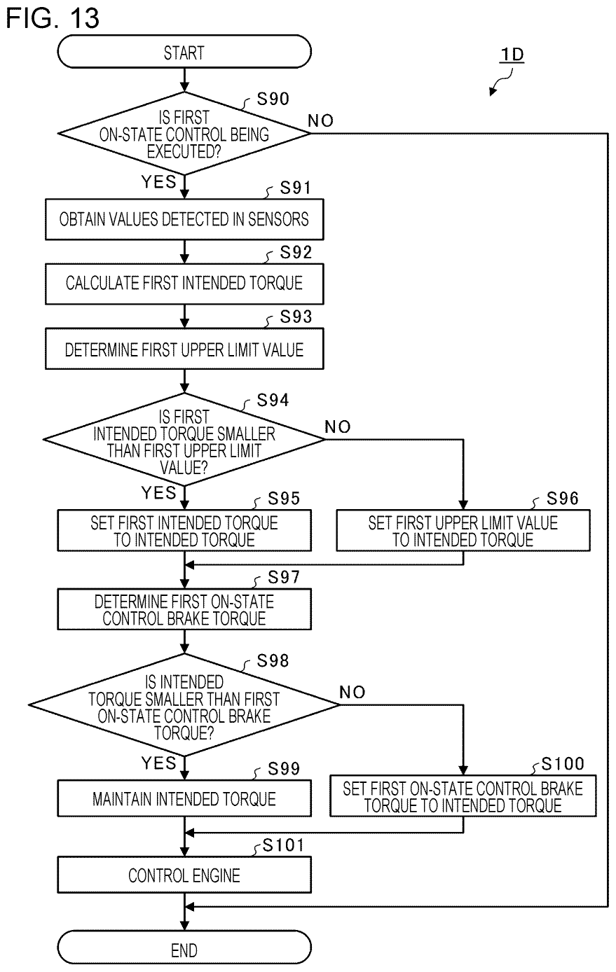

FIG. 13 is a flowchart illustrating an example of the operation of the vehicle controller 70 of a vehicle 1D according to a fifth embodiment. The configuration of the vehicle 1D of the fifth embodiment is substantially the same as that of the vehicle 1 of the first embodiment. The vehicle 1D of the fifth embodiment is different from the vehicle 1 of the first embodiment in the control operation of the vehicle controller 70. The fifth embodiment will be explained below by referring to the points different from the first embodiment while omitting an explanation of the same points as those of the first embodiment for the sake of convenience.

In the vehicle 1D of the fifth embodiment, in response to detecting of the occurrence of abnormality in the first motor generator 14 and the second motor generator 16, the vehicle controller 70 performs the first ON-state control for the first power converter 26, as in the first embodiment. In this case, in the fifth embodiment, the torque of the engine 12 may be first raised, and then, the first ON-state control may be started, as in the first embodiment. Alternatively, unlike the first embodiment, the first ON-state control may be immediately started without raising the torque of the engine 12.

As discussed above, when the first ON-state control is performed, the first ON-state control brake torque acts on the engine 12. As also discussed above, if the above-described switching condition is satisfied during the execution of the first ON-state control, the vehicle controller 70 may execute intended output control to control the engine 12.

Depending on the driving force intended by the human driver, for example, the intended torque of the engine 12 (hereinafter may also be called the intended engine torque) calculated based on the driver intended driving force may become greater than the first ON-state control brake torque acting on the engine 12. In this case, the actual torque of the engine 12 rises, which may increase the RPM of the first motor generator 14 resisting the brake torque generated in the first motor generator 14. Then, the RPM of the first motor generator 14 may deviate from the peak RPM, for example, which may lower the driving force of the axle 22.

To address this issue, in the vehicle 1D of the fifth embodiment, if the intended torque of the engine 12 is smaller than the current first ON-state control brake torque, the vehicle controller 70 maintains the intended engine torque. If the intended torque of the engine 12 becomes greater than or equal to the current first ON-state control brake torque, the vehicle controller 70 sets the current first ON-state control brake torque to the intended engine torque.

With this control operation, in the vehicle 1D of the fifth embodiment, the intended engine torque is limited to the first ON-state control brake torque or smaller. This makes it less likely to raise the RPM of the first motor generator 14, thus making it less likely to decrease the driving force of the axle 22.

Additionally, as stated above, when the first ON-state control is performed, electricity generated in the first motor generator 14 is not transferred to the battery 30, but is consumed in the first motor generator 14 or another part as heat. This may raise the temperature of the first motor generator 14 during the execution of the first ON-state control.

If the temperature of the first motor generator 14 is found to excessively rise, the vehicle controller 70 may switch from the first ON-state control to the first OFF-state control to protect the first motor generator 14.

If the first ON-state control is suddenly discontinued, however, the driving force of the axle 22 abruptly changes, which may hinder emergency assist driving of the vehicle 1D.

To address this issue, in the vehicle 1D of the fifth embodiment, the vehicle controller 70 determines a first intended torque of the engine 12 based on the accelerator operation amount. The vehicle controller 70 determines a first upper limit value, which is the upper limit value of the torque of the engine 12, based on the temperature of the first motor generator 14, so that, as the temperature of the first motor generator 14 becomes higher, the first upper limit value becomes lower. During the execution of the first ON-state control, if the first intended torque is smaller than the first upper limit value, the vehicle controller 70 sets the first intended torque to the intended torque of the engine 12 and controls the engine 12. If the first intended torque is greater than or equal to the first upper limit value, the vehicle controller 70 sets the first upper limit value to the intended torque of the engine 12 and controls the engine 12.

With this control operation, in the vehicle 1D of the fifth embodiment, as the temperature of the first motor generator 14 becomes higher, the intended torque of the engine 12 can become lower. The reduced intended torque of the engine 12 decreases the driving force of the axle 22. Even if the temperature of the first motor generator 14 excessively soars and the first ON-state control is abruptly discontinued, the driving force of the axle 22 is already attenuated and is less likely to change. The emergency assist driving of the vehicle 1D is thus less likely to be influenced by sudden switching from the first ON-state control to the first OFF-state control.

After detecting the occurrence of abnormality in the first motor generator 14 and the second motor generator 16, the vehicle controller 70 of the vehicle 1D of the fifth embodiment may execute processing illustrated in FIG. 13 at predetermined intervals. In step S90 in FIG. 13, the vehicle controller 70 determines whether the first ON-state control is being executed for the first power converter 26. If it is determined that the first ON-state control is not being executed (NO in step S90), the vehicle controller 70 terminates the processing in FIG. 13.

If it is determined that the first ON-state control is being executed (YES in step S90), the vehicle controller 70 obtains values detected in individual sensors in step S91. For example, the vehicle controller 70 may obtain the actual RPM of the engine 12 detected by the engine rotational speed sensor 36. The vehicle controller 70 may obtain the vehicle velocity detected by the vehicle velocity sensor 42. The vehicle controller 70 may obtain the accelerator operation amount detected by the accelerator sensor 38. The vehicle controller 70 may obtain the brake operation amount detected by the brake sensor 40. The vehicle controller 70 may obtain the temperature of the first motor generator 14 detected by the temperature sensor 46.

In step S92, the vehicle controller 70 calculates the current driving force intended by the driver, based on the current accelerator operation amount and the current brake operation amount, and then calculates the first intended torque of the engine 12, based on the current driving force intended by the driver and the gear ratio of the planetary gear mechanism 10.

Then, in step S93, the vehicle controller 70 determines the first upper limit value of the torque of the engine 12, based on the current temperature of the first motor generator 14. For example, the vehicle controller 70 determines the first upper limit value, based on the current temperature of the first motor generator 14 and a first upper limit value table prestored in the memory 62, for example.

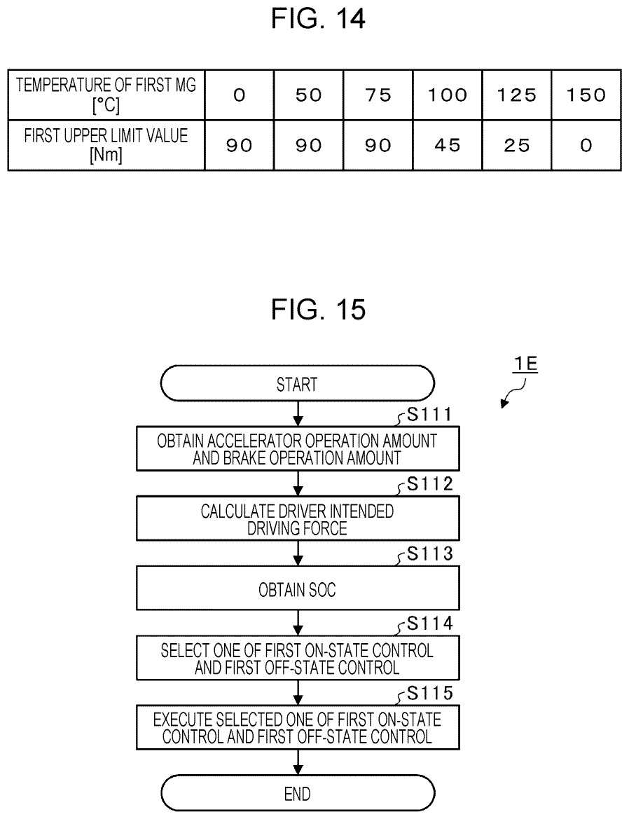

FIG. 14 illustrates an example of the first upper limit value table. As illustrated in FIG. 14, the first upper limit value table is a table in which the temperature of the first motor generator 14 and the first upper limit value of the torque of the engine 12 are correlated to each other. As illustrated in FIG. 14, as the temperature of the first motor generator 14 becomes higher, the first upper limit value is set to be lower.

Referring back to FIG. 13, after step S93, the vehicle controller 70 determines in step S94 whether the current first intended torque calculated in step S92 is smaller than the current first upper limit value determined in step S93.

If the current first intended torque is found to be smaller than the current first upper limit value (YES in step S94), the vehicle controller 70 sets the current first intended torque to the intended torque of the engine 12 in step S95 and then proceeds to step S97.

If the current first intended torque is found to be greater than or equal to the current first upper limit value (NO in step S94), the vehicle controller 70 sets the current first upper limit value to the intended torque of the engine 12 in step S96 and then proceeds to step S97.

In step S97, the vehicle controller 70 determines the current first ON-state control brake torque as follows, for example. The vehicle controller 70 calculates the current RPM of the second motor generator 16 (in other words, the RPM of the ring gear 52), based on the current vehicle velocity and the gear ratio of the reduction gear 18. The vehicle controller 70 then calculates the current RPM of the first motor generator 14 (in other words, the RPM of the sun gear 50), based on the current RPM of the second motor generator 16, the current actual RPM of the engine 12, and the gear ratio of the planetary gear mechanism 10. The vehicle controller 70 then determines the current first ON-state control brake torque acting on the engine 12, based on the RPM of the first motor generator 14 and the first ON-state control brake torque table (see FIG. 5) prestored in the memory 62.

The vehicle controller 70 then determines in step S98 whether the intended torque set in step S95 or S96 is smaller than the current first ON-state control brake torque.

If the intended torque is found to be smaller than the current first ON-state control brake torque (YES in step S98), in step S99, the vehicle controller 70 maintains the intended torque set in step S95 or S96 and then proceeds to step S101.

If the intended torque is found to be greater than or equal to the current first ON-state control brake torque (NO in step S98), in step S100, the vehicle controller 70 sets the current first ON-state control brake torque to the intended torque of the engine 12 and then proceeds to step S101.

In step S101, the vehicle controller 70 controls the engine 12 in accordance with the intended torque set in step S99 or S100.

### Sixth Embodiment

FIG. 15 is a flowchart illustrating an example of the operation of the vehicle controller 70 of a vehicle 1E according to a sixth embodiment. The configuration of the vehicle 1E of the sixth embodiment is substantially the same as that of the vehicle 1 of the first embodiment. The vehicle 1E of the sixth embodiment is different from the vehicle 1 of the first embodiment in the control operation of the vehicle controller 70. The sixth embodiment will be explained below by referring to the points different from the first embodiment while omitting an explanation of the same points as those of the first embodiment for the sake of convenience.

In the sixth embodiment, in response to detecting of the occurrence of abnormality in the first motor generator 14 and the second motor generator 16, the vehicle controller 70 performs the first ON-state control for the first power converter 26, as in the first embodiment. In this case, in the sixth embodiment, the torque of the engine 12 may be first raised, and then, the first ON-state control may be started, as in the first embodiment. Alternatively, unlike the first embodiment, the first ON-state control may be immediately started without raising the torque of the engine 12.

As discussed above, when the first ON-state control is performed, electricity generated in the first motor generator 14 is not transferred to the battery 30, but is consumed in the first motor generator 14 or another part as heat. During the first ON-state control, therefore, the battery 30 is not charged and the state of charge (SOC) of the battery 30 may decline. The SOC is an index representing the charging ratio or the charging state.

To address this issue, in the vehicle 1E of the sixth embodiment, while the occurrence of abnormality in the first motor generator 14 and the second motor generator 16 is being detected, the vehicle controller 70 calculates the current driving force intended by the human driver, based on the current accelerator operation amount and the current brake operation amount. The vehicle controller 70 of the vehicle 1E then selects one of the first ON-state control and the first OFF-state control based on a combination of the current driving force intended by the driver and the current SOC of the battery 30 and executes the selected one of the first ON-state control and the first OFF-state control.

For example, when the SOC of the battery 30 is relatively high, the vehicle controller 70 may select the first ON-state control and execute it in accordance with the step-on operation on the accelerator pedal.

This can transmit a suitable driving force to the axle 22, thereby enabling the vehicle 1E to perform emergency assist driving properly.

Even when the SOC of the battery 30 is relatively high, if the brake pedal is operated, the vehicle controller 70 may cancel the first ON-state control and start the first OFF-state control.

Even when the accelerator pedal is operated, if the SOC of the battery 30 is relatively low, the vehicle controller 70 may cancel the first ON-state control and start the first OFF-state control.

This can charge the battery 30 so as to reduce a decline in the SOC. As a result, the SOC does not become lower than the lower limit value of the SOC, thereby preventing the vehicle 1E from being inoperable.

After detecting the occurrence of abnormality in the first motor generator 14 and the second motor generator 16, the vehicle controller 70 of the vehicle 1E of the sixth embodiment may execute processing illustrated in FIG. 15 at predetermined intervals.

In step S111 in FIG. 15, the vehicle controller 70 obtains the current accelerator operation amount, based on the value detected by the accelerator sensor 38, and also obtains the current brake operation amount, based on the value detected by the brake sensor 40.

Then, in step S112, the vehicle controller 70 calculates the current driving force intended by the human driver, based on the current accelerator operation amount and the current brake operation amount.

Then, in step S113, the vehicle controller 70 estimates the current SOC, based on the value detected by the voltage sensor 44, for example.

In step S114, the vehicle controller 70 selects one of the first ON-state control and the first OFF-state control, based on the current driving force intended by the driver calculated in step S112 and the current SOC obtained in step S113. For example, the vehicle controller 70 may select one of the first ON-state control and the first OFF-state control, based on the current driving force intended by the driver, the current SOC, and a selection map prestored in the memory 62, for example.

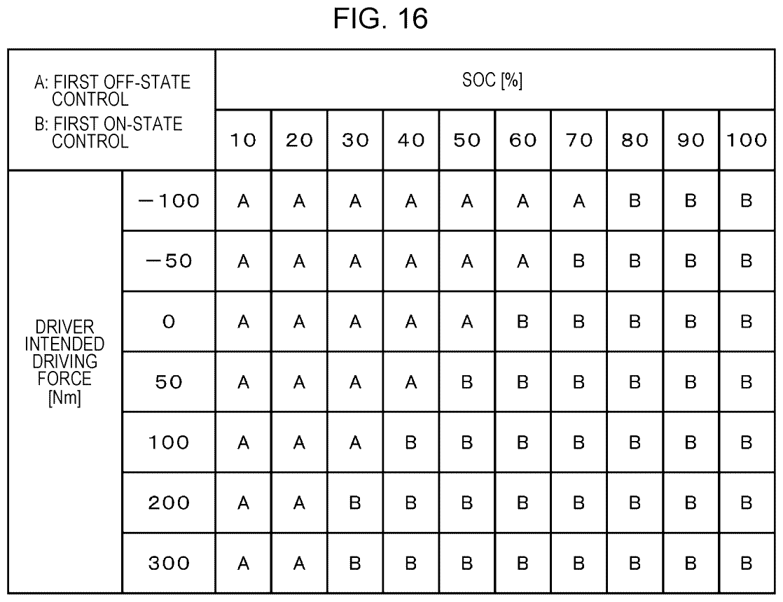

FIG. 16 illustrates an example of the selection map. In FIG. 16, “A” indicates that the first OFF-state control is selected, while “B” indicates that the first ON-state control is selected. Regarding the driver intended driving force in FIG. 16, the positive value is the intended driving force in the acceleration direction, while the negative value is the intended driving force in the deceleration direction.

As illustrated in FIG. 16, the selection map is a map in which the SOC, the driver intended driving force, and the first ON-state driving or the first OFF-state driving to be selected are correlated to each other. As illustrated in FIG. 16, as the SOC becomes higher, the first ON-state control “B” is more likely to be selected, and as the driver intended driving force becomes higher, the first ON-state control “B” is more likely to be selected. In other words, in the selection map, as the SOC becomes lower, the first OFF-state control “A” is more likely to be selected, and as the driver intended driving force becomes lower, the first OFF-state control “A” is more likely to be selected.

Referring back to FIG. 15, in step S115, the vehicle controller 70 executes the first ON-state control or the first OFF-state control selected in step S114.

The disclosure has been discussed through illustration of the embodiments with reference to the accompanying drawings. However, the disclosure is not limited to the embodiments. Obviously, many modifications and variations will be apparent to practitioners skilled in the art without departing from the scope and spirit of the disclosure and it is understood that such modifications and variations are also encompassed in the technical scope of the disclosure.

For example, the features of the above-described embodiments may be combined in a suitable manner.

The processing operations described in the specification may not necessarily be executed in chronological order described in the flowcharts and may be executed in parallel or may include an operation executed by a sub-routine.

The control device 48 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 48 including the processor 60, the vehicle controller 70, and the memory 62. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle comprising:
a planetary gear mechanism including a sun gear, a ring gear, a planet pinion, and a carrier, the carrier supporting the planet pinion rotatably;
an engine coupled to the carrier;
a first motor generator coupled to the sun gear;
a second motor generator coupled to the ring gear and an axle;
a first power converter configured to electrically coupled to the first motor generator; and
a control device,
wherein the first power converter includes a plurality of arms connected in parallel to each other, each of the arms including a first switching element and a second switching element that are connected in series to each other between a positive electrode line and a negative electrode line, a node between the first switching element and the second switching element being connected to a winding of the first motor generator,
wherein the control device comprising:
at least one processor; and
at least one memory coupled to the at least one processor,
wherein a first ON-state control operation is an operation to cause one of a group of the first switching elements of the arms and a group of the second switching elements of the arms to be in an ON state and the other one of the group of the first switching elements and the group of the second switching elements to be in an OFF state, and
wherein a first ON-state control brake torque is a brake torque to act on the engine, the brake torque to act on the engine being caused by a brake torque generated in the first motor generator when the first ON-state control operation is executed, and
wherein the at least one processor configured to execute processing comprising
determining, in response to detecting of occurrence of abnormality in the first motor generator and the second motor generator, an estimated value of the first ON-state control brake torque which is to act on the engine when it is assumed that the first ON-state control operation is executed at a current time point,
determining a first target torque, the first target torque being a torque greater than a target torque of the engine at a current time point by an amount equal to the estimated value of the first ON-state control brake torque,
determining a delay time, the delay time being a period of time which is estimated to take until an actual torque of the engine at a current time point reaches the first target torque when it is assumed that the first target torque is set to the target torque of the engine at a current time point,
setting the first target torque to the target torque of the engine, and
starting executing the first ON-state control operation after a lapse of the delay time from a time point at which the first target torque is set to the target torque of the engine.

2. The vehicle according to claim 1, wherein:
a first OFF-state control operation is an operation to cause all the first switching elements and all the second switching elements of the arms to be in the OFF state; and
the at least one processor is configured to execute processing comprising
performing an intermittent control operation to alternately repeat the first ON-state control operation and the first OFF-state control operation in a pulsating manner after starting the first ON-state control operation.

3. The vehicle according to claim 2, wherein the at least one processor is configured to execute processing comprising
changing a duty ratio based on a rotational speed difference of the engine so that the duty ratio becomes smaller as the rotational speed difference of the engine becomes greater, the duty ratio being a ratio of an execution time of the first ON-state control operation to a length of one cycle of the intermittent control operation, the rotational speed difference of the engine being a difference between a target rotational speed of the engine and an actual rotational speed of the engine.

4. The vehicle according to claim 1, wherein:
the at least one processor is configured to execute processing comprising
executing, in response to starting of the first ON-state control operation, a target rotational speed control operation to control the engine so that an actual rotational speed of the engine becomes a target rotational speed of the engine, and
switching, in a case in which a predetermined switching condition is satisfied while the target rotational speed control operation is being executed, to an intended output control operation to control the engine so that output of the engine becomes intended output, the intended output being output based on an accelerator operation amount; and
the predetermined switching condition is a condition that a rotational speed difference of the first motor generator is smaller than or equal to a predetermined first threshold and that a rotational speed difference of the engine is smaller than or equal to a predetermined second threshold, the rotational speed difference of the first motor generator being a difference between an actual rotational speed of the first motor generator and a target rotational speed of the first motor generator, the rotational speed difference of the engine being a difference between a target rotational speed of the engine and an actual rotational speed of the engine.

5. The vehicle according to claim 1, wherein:
a first lower limit value is preset, the first lower limit value being a lower limit value of a rotational speed of the engine during execution of the first ON-state control operation; and
the at least one processor is configured to execute processing comprising
determining a first target rotational speed of the engine, based on a rotational speed of the first motor generator when the brake torque generated in the first motor generator is maximized under the first ON-state control operation, and
controlling the engine during the execution of the first ON-state control operation by setting the first target rotational speed of the engine to a target rotational speed of the engine in a case in which the first target rotational speed of the engine is greater than the first lower limit value and by setting the first lower limit value of the engine to the target rotational speed of the engine in a case in which the first target rotational speed of the engine is smaller than or equal to the first lower limit value.
